(19) United States
(12) Patent Application Publication
(10) Pub. No.: US 2022/0147516 A1
(43) Pub. Date: May 12, 2022

(54) MACHINE LEARNING USING QUERY ENGINES

(71) Applicant: Twitter, Inc., San Francisco, CA (US)

(72) Inventors: Chunxu Tang, San Francisco, CA (US); Mainak Ghosh, San Francisco, CA (US); Beinan Wang, San Francisco, CA (US); Zhenxiao Luo, San Francisco, CA (US); Da Cheng, San Francisco, CA (US); Qieyun Dai, San Francisco, CA (US); Yao Li, San Francisco, CA (US); Fred Dai, San Francisco, CA (US); Hao Luo, San Francisco, CA (US); Maosong Fu, San Francisco, CA (US)

(21) Appl. No.: 17/092,019

(22) Filed: Nov. 6, 2020

(51) Int. Cl. G06F 16/245; G06F 16/248; G06N 20/00

(52) U.S. Cl. CPC G06F 16/245; G06N 20/00; G06F 16/248

(57) ABSTRACT

Methods, systems, and apparatus, including computer programs encoded on computer storage media, for performing machine learning using a query engine. One of the methods includes obtaining, from a user device and by a query engine that is configured to access one or more databases, a command to execute a user-defined function, wherein the user-defined function includes an inference call to a machine learning model, wherein the command comprises one or more model inputs to the machine learning model; obtaining, by the query engine and from the one or more databases, trained parameter values for the machine learning model; executing, by the query engine, the user-defined function, comprising processing the one or more model inputs using the machine learning model according to the obtained parameter values of the machine learning model to generate respective model outputs; and providing, to the user device and by the query engine, the generated model outputs.

### BACKGROUND

This specification relates to databases. Typically, a database is either a relational database or a non-relational database. A relational database represents and stores data in tables that have defined relationships, and is often queried using a query language, e.g., Structured Query Language (SQL). A non-relational database does not enforce relationships between tables, but rather stores data in collections that each have their own namespaces. For example, the collections of a non-relational database can be stored in respective documents, e.g. JavaScript Object Notation (JSON) documents.

This specification also relates to processing data using machine learning models. Machine learning models receive an input and generate an output, e.g., a predicted output, based on the received input. Some machine learning models are parametric models and generate the output based on the received input and on values of the parameters of the model. Some machine learning models are deep models that employ multiple layers of models to generate an output for a received input. For example, a deep neural network is a deep machine learning model that includes an output layer and one or more hidden layers that each apply a non-linear transformation to a received input to generate an output.

In some conventional machine learning systems, users must export data from a database to an external system, e.g., by downloading the data onto a local user device or onto a separate remote distributed environment, and then process the data using the external system in order to perform machine learning on the data. For example, using conventional techniques, a user might download training examples from a database, pre-process the training examples in order to transform the data into a format that is required by a local machine learning system, and then train a machine learning model using the training examples on the local machine learning system. Exporting data from a database system and then pre-processing the data locally can be both time and computationally inefficient. Exporting data from a database system can also increase the storage footprint of the system, as a local copy of the data can be stored during execution of the local machine learning system. Exporting data from a database system can also introduce privacy concerns if the exported data include personal information of users.

In some conventional machine learning systems, a user that is a member of an organization must know a particular coding language, e.g., Python or Java, in order to execute machine learning jobs for the organization. For example, after exporting training data from a database to a local system, the user might need to write Java code that implements a particular training algorithm using the training data. Many members of the organization, however, might not know the particular coding language used by the organization to perform machine learning. As a particular example, many data scientists do most of their work using a particular query language, e.g., SQL, and are therefore comfortable writing commands in the particular query language, but do not know other coding languages. In conventional machine learning systems, these data scientists would be unable to execute machine learning jobs for the organization, and might have to outsource such jobs to other members of the organization, decreasing efficiency of the organization.

### SUMMARY

This specification describes a system that performs machine learning using a query engine. The query engine is configured to execute one or more user-defined functions to perform machine learning using data stored in one or more databases associated with the query engine. For example, a user-defined function of the query engine can process data stored in the one or more databases to generate predictions from the data.

In this specification, a query engine is a system of one or more computers that is configured to receive a command in a particular query language, e.g., a declarative query language such as SQL, interpret the command, and retrieve data according to the command from one or more databases associated with the query engine.

In this specification, a user-defined function is one or more computer-executable programs that have been written by a user of a system and deployed onto the system. An entity, e.g., the user or an external system, can then submit commands to the system to execute the user-defined function, optionally with one or more arguments defining values for respective parameters of the user-defined function. For brevity, a user-defined function is also referred to as a “UDF.” In this specification, a UDF command is a command submitted to a query engine, e.g., by a user device or by an external system, that references one or more UDFs of the query engine.

For example, the query engine can train a machine learning model using a user-defined function that one or more users designed to execute training. In particular, the query engine can receive a command to execute the training UDF that identifies a set of training examples for the machine learning model. The set of training examples can be stored in one or more databases of the query engine. The query engine can retrieve the training examples from the one or more databases and execute the training UDF to generate trained parameter values for the machine learning model. In some implementations, the query engine stores the trained parameter values in one or more databases of the query engine. Instead or in addition, the query engine can respond to the training command with the trained parameter values.

As another example, the query engine can perform inference on a trained machine learning model using a user-defined function that one or more users designed to execute inference; that is, the query engine can process model inputs to generate model outputs characterizing predictions about the model inputs according to the user-defined function. In particular, the query engine can receive a command to execute the inference UDF that includes one or more model inputs for the machine learning model. Instead or in addition, the command can reference one or more model inputs that are stored in one or more databases of the query engine. The trained parameter values of the machine learning model can be stored in the one or more databases of the query engine. The query engine can retrieve the parameter values (and, optionally, the model inputs) from the one or more databases and execute the inference UDF to generate respective model outputs for the one or more model inputs. The query engine can then respond to the inference command with the model outputs.

Particular embodiments of the subject matter described in this specification can be implemented so as to realize one or more of the following advantages.

Using techniques described in this specification, a system can perform machine learning on data stored in databases managed by a query engine without needing to export the data from the query engine. That is, the machine learning can be performed by the query engine itself in response to receiving a command from the system. Eliminating the need to export data can significantly improve the time, storage, and computational efficiency of the system. Furthermore, in some implementations, the query engine is configured to execute workloads, e.g., training or inference workloads, across a distributed system of multiple nodes, further improving the efficiency of the system.

In some implementations described in this specification, a query engine can be configured to execute an entire machine learning pipeline, including training, evaluating, refining, and performing inference on one or more machine learning models. This can eliminate the need for users to maintain multiple different systems to perform respective tasks within the pipeline and send large amounts of data between the different systems.

By processing data stored in a database using a query engine without exporting any of the data out of the query engine, a system can ensure the privacy of the data. That is, by running machine learning jobs on the query engine using data stored in the corresponding databases, the system can ensure that any personal information in the data is not disclosed to an external system. Furthermore, by keeping all of the data within the query engine, a system can ensure that regulations regarding the handling of personal data, e.g., HIPAA requirements in the United States or GDPR requirements in the European Union, are followed. As a particular example, the query engine can enforce a retention policy for personal data, whereas the system might be unable to ensure that the retention policy is followed if the system exports the data out of the query engine. As another particular example, the query engine can enforce access controls to ensure that only those individuals authorized to view and process the data are able to do so.

Using techniques described in this specification, one or more members of an organization can write one or more user-defined functions in a particular programming language that the organization uses for machine learning, and then deploy the user-defined functions onto the query engine. Each other member of the organization can then call the deployed user-defined functions using the query language of the query engine, even if the member does not know the particular programming language. That is, the commands to the UDFs of the query engine can be written in the query language (e.g., Datalog), even though the UDFs are implemented using the particular programming language (e.g., Python). Thus, each user can write a command to that query engine that is specific to the user's particular machine learning use case. Continuing the particular example above, using techniques in this specification, data scientists who do not know the particular programming language can process data using machine learning without needing to ask the assistance of a software engineer colleague.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example query engine deploying a user-defined function.

FIGS. 2A-D are diagrams of an example query engine executing user-defined functions to perform machine learning.

FIG. 3 is a flowchart of an example process for performing machine learning using a query engine.

Like reference numbers and designations in the various drawings indicate like elements.

### DETAILED DESCRIPTION

This specification describes a system that performs machine learning using a query engine, e.g., by generating trained parameters for a machine learning model on the query engine or generating predictions using a machine learning model on the query engine. The query engine is configured to execute one or more user-defined functions to perform machine learning using data stored in databases associated with the query engine.

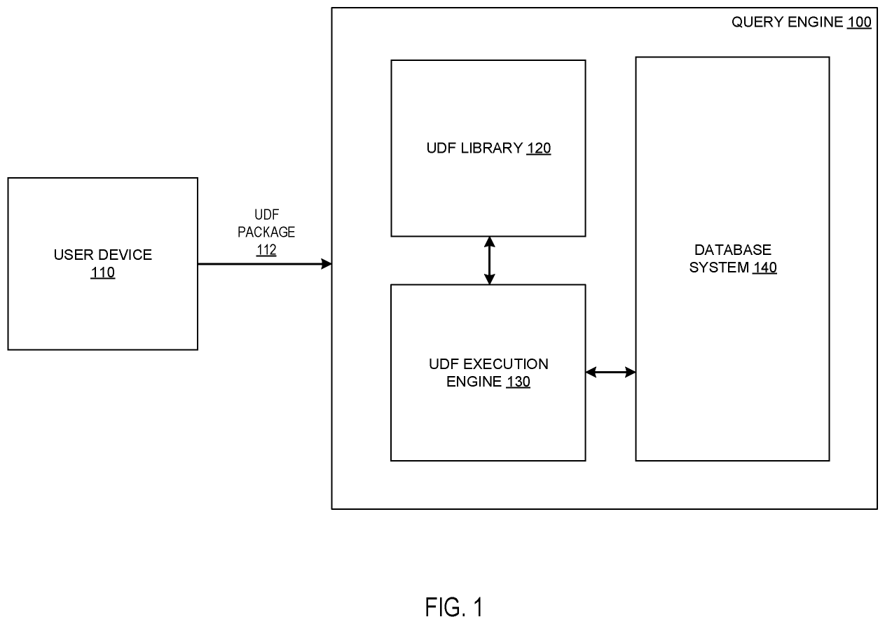

FIG. 1 is a diagram of an example query engine 100. The query engine 100 is an example of a system implemented as computer programs on one or more computers in one or more locations, in which the systems, components, and techniques described below can be implemented.

The query engine 100 includes a UDF library 120, a UDF execution engine 130, and a database system 140.

The database system 140 includes one or more databases stored on a system of one or more computers located in one or more locations. For example, the database system 140 can be hosted within a data center, which can be a distributed computing system have hundreds or thousands of computers in one or more locations. The query engine 100 is configured to store data in and retrieve data from the database system 140 on behalf of one or more external systems, e.g., one or more user devices 110. For example, the query engine 100 can be configured to receive commands from the external system in a particular query language, e.g., a declarative query language. A few non-limiting examples of query languages include: Analog, Cypher, Datalog, Data Mining Extensions (DMX), GraphQL, Gremlin, Lightweight Directory Access Protocol (LDAP), Object Constraint Language (OCL), and SQL.

The UDF library 120 stores data characterizing each user-defined function that has been deployed onto the query engine 100. For example, for each user-defined function deployed onto the query engine 100, the UDF library 120 can store a package that includes all the data required to execute the user-defined function. For example, the package of a user-defined function can include one or more executable scripts of the user-defined function. The scripts can be written in a programming language that is different from the query language of the query engine 100, e.g., an imperative programming language. A few non-limiting examples of imperative programming languages include: C, C#, C++, Go, Java, Perl, PHP, Python, and Ruby. The package of a user-defined function can also include one or more software libraries invoked by the user-defined function and/or any supporting files required for executing the user-defined function.

The UDF execution engine 130 is configured to execute the one or more user-defined functions deployed onto the query engine 100. That is, the UDF execution engine 130 can receive a command, e.g., from a user device or an external system, to execute a particular user-defined function of the query engine 100. The command can be a command written in the query language of the query engine 100 that identifies data stored in the database system 140, where the identified data is required to execute the particular user-defined function. The UDF execution engine 130 can then obtain the package of the particular user-defined function from the UDF library 120, and execute the particular user-defined function according to the received command. During the execution of the particular user-defined function, the UDF execution engine 130 can obtain additional data from the database system 140, e.g., data that is identified in the package obtained from the UDF library 120 or in arguments of the received command. A user device 120 can launch a new user-defined function on the query engine 100. To do so, the user device 120 can submit a UDF package 112. As described above, the UDF package 112 can include all the data required to execute the user-defined function, e.g., one or more executable scripts of the user-defined function.

In some implementations, the user-defined function can invoke one or more functions or libraries that are already deployed onto the query engine 100, e.g., one or more functions that are natively provided by the query engine 100 and/or one or more other user-defined functions that are already stored in the UDF library 120.

Instead or in addition, the user-defined function can invoke one or more external functions or libraries. In some such implementations, the UDF package 112 can include all data required to execute the external functions or libraries on the query engine 100. When the query engine 100 receives the UDF package 112, the query engine 100 can execute an installation process on the external libraries, so that the UDF execution engine 130 can invoke the external libraries upon receiving a command to execute the new user-defined function corresponding to the UDF package 112.

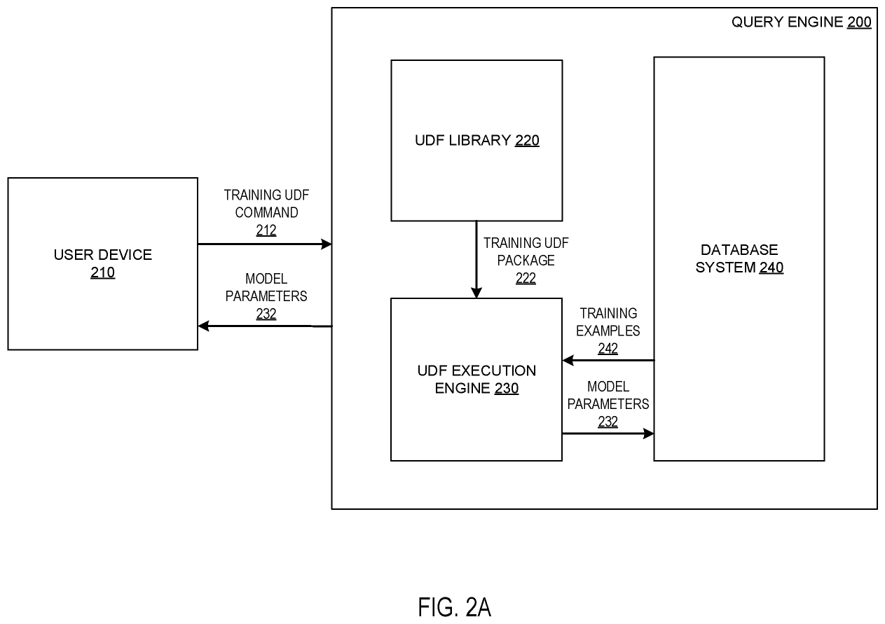

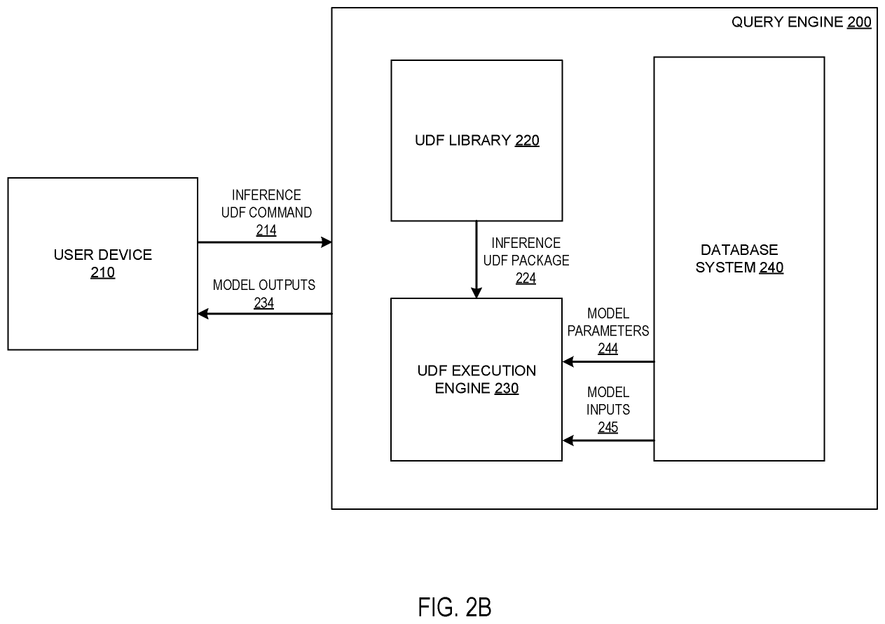

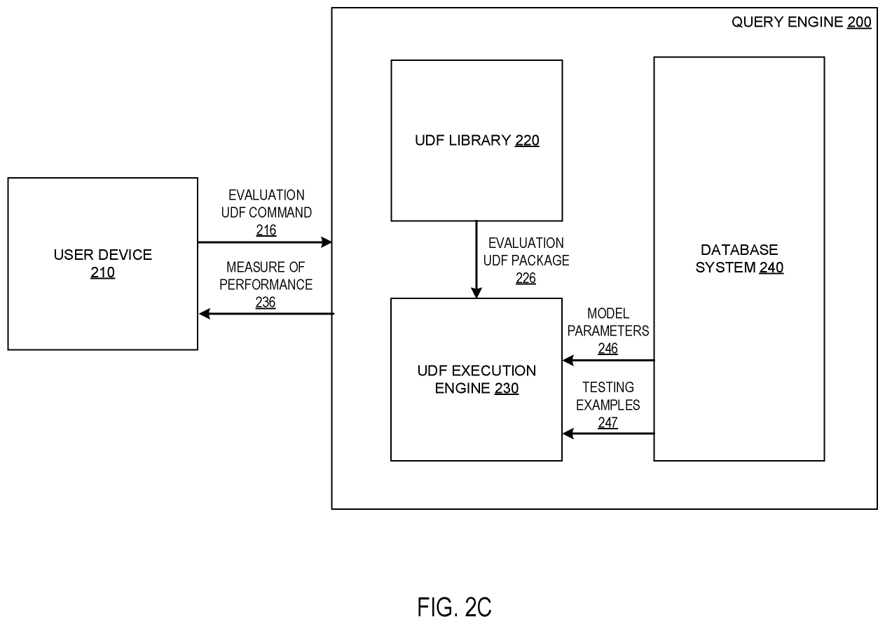

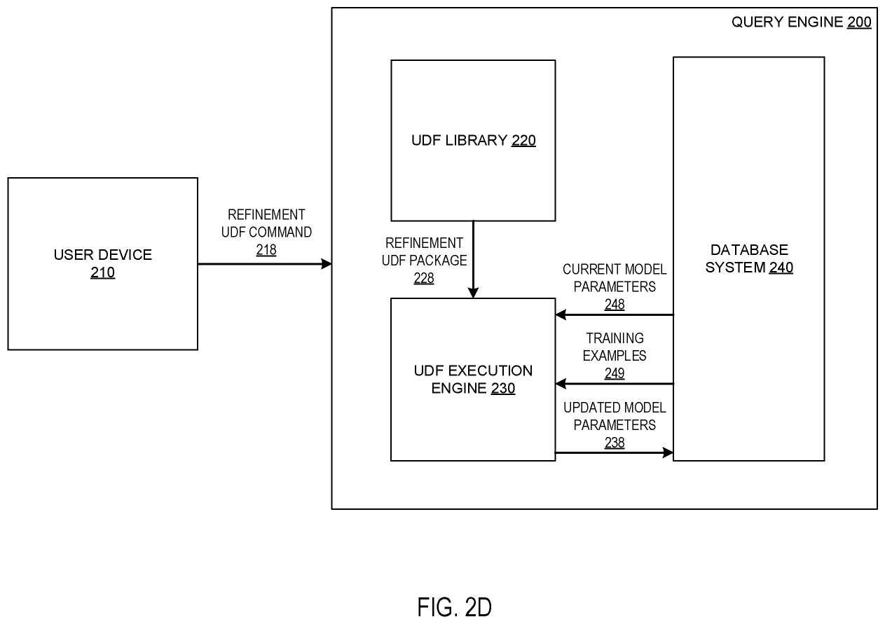

FIGS. 2A-D are diagrams of an example query engine 200 executing user-defined functions to perform machine learning. FIG. 2A depicts the query engine 200 training a machine learning model. FIG. 2B depicts the query engine 200 performing inference on a trained machine learning model. FIG. 2C depicts the query engine 200 evaluating the performance of a trained machine learning model. FIG. 2D depicts the query engine 200 refining a trained machine learning model, i.e., updating the parameters of the machine learning model.

The query engine 200 includes a UDF library 220, a UDF execution engine 230, and a database system 240. The query engine 200 is an example of a system implemented as computer programs on one or more computers in one or more locations, in which the systems, components, and techniques described below can be implemented.

Referring to FIG. 2A, a user device 210 can send a training UDF command 212 to the query engine 200. The training UDF command 212 is a command to execute a user-defined function deployed on the query engine 200 that was designed by users of the query engine 200 to train a machine learning model, i.e., to generate trained parameters for the machine learning model. For example, the training UDF command 212 can be designed to execute a particular training algorithm for training a neural network, e.g., training a neural network using supervised learning with backpropagation. The training UDF command 212 can include one or more arguments defining parameters of the training process; for example, the training UDF command 212 can include one or more arguments defining hyperparameter values for the training, e.g., a step size for performing gradient descent.

Upon receiving the training UDF command 212, the UDF execution engine 230 can obtain a training UDF package 222 stored in the UDF library 220. The training UDF package 222 is a software package corresponding to the training user-defined function invoked by the training UDF command 212. The UDF execution engine 230 can then execute the training user-defined function according to the command 212.

The training UDF command 212 can be a command written in the query language of the query engine 200 that identifies a location of multiple training examples 242 in the database system 240 that are to be used for training the machine learning model. The UDF execution engine 230 can obtain the training examples 242 from the database system 240, and process the training examples 242 according to the training user-defined function to generate trained model parameters 232 for the machine learning model. That is, the UDF execution engine 230 can obtain the training examples 242 that are stored in the query engine 200 and process the training examples 242 on the query engine 200 to generate the model parameters 232, so that the user device 210 does not need to handle the training examples 242 at all.

In some implementations, the training user-defined function can include instructions to pre-process the training examples 242 to put the training examples 242 into a form that is better for training. For example, the training user-defined function can include instructions to tokenize, normalize, or otherwise reformat the obtained training examples 242 before training the machine learning model. In these implementations, the UDF execution engine 230 can pre-process the training examples 242 according to the instructions of the training user-defined function.

For example, if the input to the machine learning model includes text data, the training user-defined function can include instructions to process the training examples 242 using a pre-processing pipeline that includes one or more transformations of the input text data, e.g., removing punctuations, stemming, and normalization. As a particular example, if the query language of the of the query engine 200 is SQL, then the training user-defined function can include a SQL statement that obtains the training examples 242 from the database system 240 and pre-processes the training examples 242, e.g.:

SELECT normalize(stem(remove_punc(training_sentence))) FROM training set In some implementations, the query engine 200 can distribute the execution of the training user-defined function across multiple different nodes of the query engine 200. For example, the query engine 200 can include tens, hundreds, or thousands of worker nodes that are coordinated by one or more coordinator nodes. The UDF execution engine 230 can instruct the multiple nodes of the query engine 200 to execute respective tasks of the training user-defined function in parallel, which can significantly decrease the time it takes to execute the training user-defined function and generate trained model parameters 232.

As a particular example, the UDF execution engine 230 can search for optimal values of hyperparameters of the machine learning model across multiple different nodes of the query engine 200. For example, the UDF execution engine 230 can execute the training user-defined function using different sets of hyperparameter values on respective different nodes, generating different candidate sets of trained model parameters. The UDF execution engine 230 can determine a measure of the performance of the candidate sets of trained model parameters, e.g., by determining the accuracy of the machine learning model when using each respective candidate set of model parameters. The UDF execution engine 230 can then select a particular candidate set of model parameters to be the final model parameters 232 according to the respective measures of performance, e.g., by selecting the candidate set of model parameters with the highest corresponding accuracy.

In some implementations, after completing the training user-defined function, the query engine 200 can provide the model parameters 232 to the user device 210. Instead or in addition, the query engine 200 can store the model parameters 232 in the database system 240. The location of the model parameters 232 can then be referenced by subsequent inference commands that instruct the query engine 200 to perform inference using the trained machine learning model; this process is described in more detail below with reference to FIG. 2B. By storing the model parameters 232 in the database system 240, the query engine 200 can give the model parameters 232 persistence, allowing one or more different user devices 210 and/or other external systems to subsequently use the model parameters 232.

As a particular example, if the query language of the query engine 200 is SQL, then the training UDF command 212 can be the following SQL command:

INSERT INTO iris_classifier (
SELECT
‘classifier1’, learn_classifier(‘svm’, params, species, features(sepal_length,
sepal_width, petal_length, petal_width)) AS model
FROM iris
)

In this example, the database system 240 includes a SQL table called “iris_classifier” that stores the trained model parameters of a machine learning model called “classifier1” configured to predict the particular species of an iris flower. In particular, the user-defined function called “learn_classifier” executes training of a support vector machine (“svm”) that receives as input the features of the iris flower (including the respective length and width of the sepal and petal of the iris flower) and outputs a prediction of the species of the iris flower. The user-defined function can also include a “params” parameter that represents model hyperparameters that are to be used during training of machine learning model. After training the “classifier1” machine learning model, the UDF execution engine 230 can store the trained parameters of the machine learning model in the “iris_classifier” table of the database system 240

Referring to FIG. 2B, the user device 210 can send an inference UDF command 214 to the query engine 200. The inference UDF command 214 is a command to execute a user-defined function deployed on the query engine 200 that was designed by users of the query engine 200 to perform inference using a trained machine learning model, i.e., to process model inputs using the trained machine learning model to generate model outputs.

Upon receiving the inference UDF command 214, the UDF execution engine 230 can obtain an inference UDF package 224 stored in the UDF library 220. The inference UDF package 224 is a software package corresponding to the inference user-defined function invoked by the inference UDF command 214. The UDF execution engine 230 can then execute the inference user-defined function according to the command 214.

The inference UDF command 214 can be a command written in the query language of the query engine 200 that identifies a location of trained model parameters 244 of the machine learning model in the database system 240. For example, the model parameters 244 can have been generated using a training user-defined function and then stored in the database system 240, as described above with respect to FIG. 2A. As described above, by storing the model parameters 244 in the database system 240, multiple different user devices 210 and/or other external systems can each submit inference UDF commands 214 to the query engine.

In some implementations, the inference UDF command 214 can identify a location of one or more model inputs 245 in the database system 240 that are to be processed by the machine learning model to generate respective model outputs. That is, the model parameters 244 and the model inputs 245 can both be stored in the database system 240. In some other implementations, the inference UDF command 214 includes the one or more model inputs 245. That is, the model inputs 245 can be provided directly by the user device 210.

The UDF execution engine 230 can obtain the model parameters 244 (and, optionally, the model inputs 245) from the database system 240, and process the model inputs 245 using the machine learning model according to the model parameters 244 to generate a respective model output for each model input 245. That is, the UDF execution engine 240 can obtain the model parameters 244 and the model inputs 245 that are stored in the query engine 200 and process the model inputs 245 on the query engine 200 to generate the model outputs, so that the user device 210 does not need to handle either the model parameters 244 or the model inputs 245 at all.

In some implementations, the inference user-defined function can include instructions to pre-process the model inputs 245 to put the model inputs 245 into a form that can be received by the machine learning model. For example, the training user-defined function can include instructions to tokenize, normalize, or otherwise reformat the model inputs 245. In these implementations, the UDF execution engine 230 can pre-process the model inputs 245 according to the instructions of the inference user-defined function.

As described above, in some implementations, the query engine 200 can distribute the execution of the inference user-defined function across multiple different nodes of the query engine 200. As a particular example, the UDF execution engine 230 can process each model input 245 on a respective different node of the query engine 200 in parallel.

After completing the inference user-defined function, the query engine 200 can provide the generated model outputs 234 to the user device 210. Instead or in addition, the query engine 200 can store the model outputs 234 in the database system 240, e.g., in a location in the database system 240 identified in the inference UDF command 214.

As a particular example, if the query language of the query engine 200 is SQL, then the inference UDF command 214 can be the following SQL command:

SELECT classify (features(5.9, 3, 5.1, 1.8), model)
FROM(
SELECT model FROM iris_classifier WHERE name=’classifier1’
)

Continuing the example described above with respect to FIG. 2A, the database system 240 includes a SQL table called “iris_classifier” that stores the trained model parameters of a machine learning model called “classifier1” that is configured to predict the particular species of an iris flower. The user-defined function called “classify” executes inference on the machine learning model. In this case, the inference UDF command includes a single model input 245 that identifies the features of a particular iris flower. In this example, the particular iris flower has a sepal length of 5.9, a sepal width of 3, a petal length of 5.1, and a petal width of 1.8. The UDF execution engine 230 can execute the “classify” user-defined function to predict the species of the particular iris flower.

Referring to FIG. 2C, the user device 210 can send an evaluation UDF command 216 to the query engine 200. The evaluation UDF command 216 is a command to execute a user-defined function deployed on the query engine 200 that was designed by users of the query engine 200 to evaluate the performance of a trained machine learning model, i.e., to process one or more testing examples using the trained machine learning model to generate model outputs and determine an accuracy of the model outputs.

Upon receiving the evaluation UDF command 216, the UDF execution engine 230 can obtain an evaluation UDF package 226 stored in the UDF library 220. The evaluation UDF package 226 is a software package corresponding to the evaluation user-defined function invoked by the evaluation UDF command 216. The UDF execution engine 230 can then execute the evaluation user-defined function according to the command 216.

The evaluation UDF command 216 can be a command written in the query language of the query engine 200 that identifies a location of trained model parameters 246 of the machine learning model in the database system 240. For example, the model parameters 246 can have been generated using a training user-defined function and stored in the database system 240, as described above with reference to FIG. 2A. The evaluation UDF command 216 can also identify a location of one or more testing examples 247 in the database system 240 that are to be processed by the machine learning model to evaluate the performance of the machine learning model. Each testing examples 247 can include i) a model input and ii) a ground-truth output corresponding to the model input. The ground-truth output represents the model output that the machine learning model should generate in response to processing the model input.

The UDF execution engine 230 can obtain the model parameters 246 and the testing examples 247 from the database system 240, and process the training examples 247 using the machine learning model according to the model parameters 246. In particular, the UDF execution engine 247 can process the model inputs of the training examples 247 to generate respective model outputs, according to the evaluation UDF command 216. The UDF execution engine can determine an error between the generated model outputs and the corresponding ground-truth outputs of the trained examples 247. The UDF execution engine can then generate a measure of performance 236 of the machine learning model according to the evaluation UDF command 216, e.g., by determining an accuracy of the model outputs. In other words, the UDF execution engine 240 can obtain the model parameters 246 and testing examples 247 that are stored in the query engine 200 and process the testing examples 247 on the query engine 200 to generate the measure of performance 236, so that the user device 210 does not need to handle either the model parameters 246 or the testing examples 247 at all.

In some implementations, the evaluation user-defined function can include instructions to pre-process the testing examples 247 to put the testing examples 247 into a form that can be received by the machine learning model. In these implementations, the UDF execution engine 230 can pre-process the testing examples 247 according to the instructions of the evaluation user-defined function.

As described above, in some implementations, the query engine 200 can distribute the execution of the evaluation user-defined function across multiple different nodes of the query engine 200. As a particular example, the UDF execution engine 230 can process each testing example 247 on a respective different node of the query engine 200 in parallel.

After completing the evaluation user-defined function, the query engine 200 can provide the measure of performance 236 to the user device 210.

Referring to FIG. 2D, the user device 210 can send a refinement UDF command 218 to the query engine 200. The refinement UDF command 218 is a command to execute a user-defined function deployed on the query engine 200 that was designed by users of the query engine 200 to refine the model parameters of the trained machine learning mode, i.e., to further train, or “fine-tune,” the model parameters of the machine learning model. Upon receiving the refinement UDF command 218, the UDF execution engine 230 can obtain a refinement UDF package 228 stored in the UDF library 220. The refinement UDF package 228 is a software package corresponding to the refinement user-defined function invoked by the refinement UDF command 218. The UDF execution engine 230 can then execute the refinement user-defined function according to the command 218.

The refinement UDF command 218 can be a command written in the query language of the query engine 200 that identifies a location of the current model parameters 248 of the machine learning model in the database system 240. For example, the current model parameters 248 can have been generated using a training user-defined function and stored in the database system 240, as described above with reference to FIG. 2A. The refinement UDF command 218 can also identify a location of multiple training examples 249 in the database system 240 that are to be used for refining the current parameters 248 of the machine learning model.

The UDF execution engine 230 can obtain the current model parameters 248 and the training examples 249 from the database system 240, and process the training examples 249 using the machine learning model according to the refinement user-defined function in order to update the current model parameters 248 and generate updated model parameters 238 for the machine learning model. That is, the UDF execution engine 230 can obtain the training examples 249 that are stored in the query engine 200 and process the training examples 249 on the query engine 200 to generate the updated model parameters 238, so that the user device 210 does not need to handle the training examples 249 at all.

In some implementations, the refinement user-defined function can include instructions to pre-process the training examples 249 to put the training examples 249 into a form that can be received by the machine learning model. In these implementations, the UDF execution engine 230 can pre-process the training examples 249 according to the instructions of the evaluation user-defined function.

As described above, in some implementations, the query engine 200 can distribute the execution of the refinement user-defined function across multiple different nodes of the query engine 200. As a particular example, the UDF execution engine 230 can process different training examples 249 across different nodes of the query engine 200 in parallel. As another particular example, the UDF execution engine 230 can update the current model parameters 248 using different sets of hyperparameter values on respective different nodes, generating different candidate sets of updated model parameters. The UDF execution engine 230 can determine a measure of the performance of the candidate sets of updated model parameters, e.g., by determining the accuracy of the machine learning model when using each respective candidate set of updated model parameters. The UDF execution engine 230 can then select a particular candidate updated model parameters to be the updated model parameters 238 according to the respective measures of performance, e.g., by selecting the candidate set of updated model parameters with the highest corresponding accuracy.

After completing the refinement user-defined function, the query engine 200 can store the updated model parameters 238 in the database system 240, e.g., in the same location that the previous model parameters 248 had been stored. By always storing the current version of the model parameters in the database system 240, the query engine 200 can both continuously perform further training on the model parameters, and use the most up-to-date model parameters to process model inputs to generate predictions. For example, one or more different user devices 210 and/or other external systems can each submit refinement UDF commands 218 to the query engine 200 at respective subsequent time points to further update the model parameters of the machine learning model using new training data. As a particular example, if the query language of the query engine 200 is SQL, then the refinement UDF command 218 can be the following SQL command:

INSERT INTO iris_classifier (
SELECT
‘classifier1,’ learn_classifier_tune(‘svm’, param_grid, metric1, species,
features(sepal_length, sepal_width, petal_length, petal_width)) AS model
FROM iris
)

Continuing the example described above with respect to FIG. 2A, the database system 240 includes a SQL table called “iris_classifier” that stores trained model parameters of a machine learning model called “classifier1” that is configured to predict the particular species of an iris flower using the length and width of the sepal and petal of the iris flower. The user-defined function called “learn_classifier_tune” updates the model parameters of the machine learning model. In particular, the refinement UDF command 218 can include a grid of hyperparameters “param_grid” that the refinement user-defined function will use to fine-tune the machine learning model; e.g., the grid of hyperparameters can be provided as a HashMap. The refinement user-defined function can include instructions to train a different set of updated model parameters for each element of param_grid, and identify the set of updated model parameters that perform the best. The refinement UDF command 218 can identify a metric “metricl” that can be used to determine the performance of each set of updated model parameters. After determining the highest-performing set of updated model parameters, the query engine 200 can place the updated model parameters into the “classifier1” location of the “iris_classifier” SQL table.

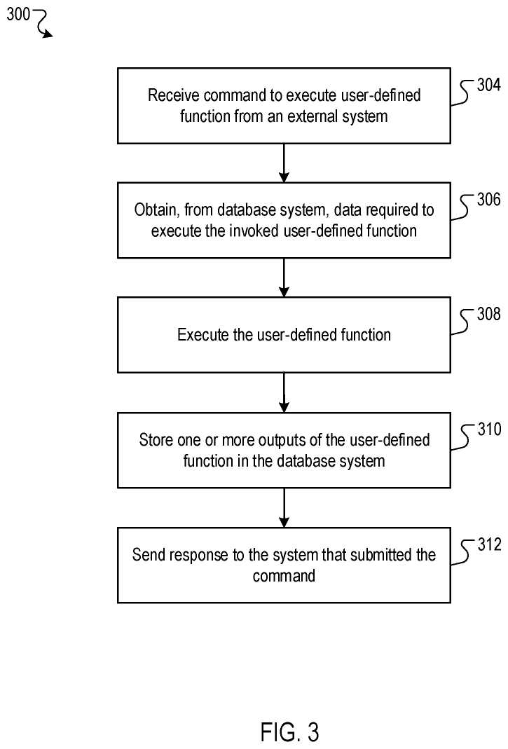

FIG. 3 is a flowchart of an example process 300 for performing machine learning using a query engine. The process 300 can be implemented by one or more computer programs installed on one or more computers and programmed in accordance with this specification. For convenience, the process 300 will be described as being performed by a system of one or more computers located in one or more locations. For example, a query engine, e.g., the query engine 100 depicted of FIG. 1, appropriately programmed in accordance with this specification, can perform the process 300.

The system receives a command to execute a user-defined function (step 304). The system can receive the command from a user device or some other external system. The command can be written in a query language.

The user-defined function can include one or more computer programs designed by users of the system to perform machine learning and launched by the users onto the system. For example, the user-defined function can be designed to train a machine learning model, generate predictions using a machine learning model, evaluate a machine learning model, or refine the model parameters of a machine learning model. The user-defined function can be written in one or more programming languages that are different from the query language.

The machine learning model can be configured to perform any machine learning task. For example, the machine learning task can be a speech recognition task, where the machine learning model is configured to process a representation of an audio waveform to generate an output that characterizes a sequence of phonemes, characters, or words corresponding to the audio waveform. As another example, the machine learning task can be a video analysis task, where the machine learning model is configured to process a sequence of video frames to generate an output that characterizes the video frames, e.g., by characterizing whether the video frames depict a person performing a particular action. As another example, the machine learning task can be a natural language processing task, where the machine learning model is configured to process a portion of text to generate an output that characterizes the portion of text, e.g., by characterizing a translation of the portion of text into a different natural language. As another example, the machine learning task can be an image processing task, where the machine learning model is configured to process an input that includes an image to generate a corresponding output, e.g., a classification output, a regression output, or a combination thereof.

The system obtains, from a database system, data required to execute the user-defined function (step 306). The location of the data in the database system can be identified in the command.

For example, if the user-defined function is a training function, then the system can obtain multiple training examples from the database system. As another example, if the user-defined function is an inference function, then the system can obtain model parameters and/or model inputs from the database system. As another example, if the user-defined function is an evaluation function, then the system can obtain model parameters and/or testing examples from the database system. As another example, if the user-defined function is a refining function, then the system can obtain the current model parameters of the machine learning model and/or training examples from the database system.

The system executes the user-defined function (step 308). For example, the system can obtain a package corresponding to the user-defined function from a UDF library and execute the user-defined function using the obtained package.

The system stores one or more outputs of the user-defined function in the database system (step 310).

For example, if the user-defined function is a training function, then the system can store the generated model parameters in the database system. As another example, if the user-defined function is an inference function, then the system can store the model outputs generated by the machine learning model in the database system. As another example, if the user-defined function is an evaluation function, then the system can store one or more measures of performance of the machine learning model in database system. As another example, if the user-defined function is a refining function, then the system can store the updated model parameters for the machine learning model in the database system.

In some implementations, the system does not store any outputs in the database system and proceeds to step 312.

The system sends a response to the system that submitted the command to execute the user-defined function (step 312). For example, the system can send the response to the user device that submitted the command, or the external system that submitted the command. The response can confirm that the system executed the user-defined function. The response can also include one or more outputs of the user-defined function.

For example, if the user-defined function is a training function, then the system can respond to the command with the trained model parameters of the machine learning model. As another example, if the user-defined function is an inference function, then the system can respond to the command with the model outputs generated by the machine learning model. As another example, if the user-defined function is an evaluation function, then the system can respond to the command with one or more measures of performance of the machine learning model. As another example, if the user-defined function is a refining function, then the system can respond to the command with the updated model parameters.

In some implementations, the system does not send a response and ends the process 300 after step 310.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:

obtaining, from a user device and by a query engine that is configured to access one or more databases, a command to execute a user-defined function of the query engine, wherein:
the command is written in a query language;
the user-defined function has been written and launched onto the query engine by users of the query engine using one or more programming languages that are different from the query language in which the command is written; and
the user-defined function includes an inference call to a trained machine learning model, wherein the command comprises one or more model inputs to the machine learning model;

obtaining, by the query engine and from the one or more databases, trained parameter values for the machine learning model;

executing, by the query engine, the user-defined function, comprising processing the one or more model inputs using the machine learning model according to the obtained parameter values of the machine learning model to generate respective model outputs; and

providing, to the user device and by the query engine, the generated model outputs.

Embodiment 2 is the method of embodiment 1, wherein:

the command comprises a plurality of model inputs; and

executing the user-defined function further comprises executing the user-defined function on each of a plurality of nodes of the query engine, comprising processing each of the plurality of model inputs using the machine learning model on a respective node of the plurality of nodes.

Embodiment 3 is the method of any one of embodiments 1 or 2, further comprising training the machine learning model, the training comprising:

obtaining, from a second user device and by the query engine, a second command to execute a second user-defined function of the query engine, wherein:
the second command is written in the query language;
the second user-defined function has been written and launched onto the query engine by users of the query engine using one or more programming languages that are different from the query language in which the second command is written; and
the second command comprises data identifying a plurality of training examples stored in the one or more databases;

obtaining, by the query engine and from the one or more databases, the plurality of training examples;

executing, by the query engine, the second user-defined function, comprising processing the plurality of training examples using the machine learning model to generate trained parameter values for the machine learning model; and

storing, in the one or more databases, the trained parameter values.

Embodiment 4 is the method of embodiment 3, wherein executing the second user-defined function further comprises executing the second user-defined function on each of a plurality of nodes of the query engine, comprising:

processing, by each of the plurality of nodes of the query engine, the plurality of training examples using the machine learning model according to a respective different set of hyperparameter values;

determining, for each of the plurality of different sets of hyperparameter values, a measure of performance of the set of hyperparameter values;

selecting a particular set of hyperparameter values from the plurality of different sets of hyperparameter values according to the determined measures of performance; and

generating the trained parameter values for the machine learning model according to the selected set of hyperparameter values.

Embodiment 5 is the method of any one of embodiments 3 or 4, wherein executing the second user-defined function further comprises pre-processing, by the query engine, the plurality of training examples before processing the training examples using the machine learning model.

Embodiment 6 is the method of any one of embodiments 1-5, further comprising evaluating the machine learning model, the evaluating comprising:

obtaining, from a third user device and by the query engine, a third command to execute a third user-defined function of the query engine, wherein:
the third command is written in the query language;
the third user-defined function has been written and launched onto the query engine by users of the query engine using one or more programming languages that are different from the query language in which the third command is written; and
the third command comprising data identifying a plurality of testing examples stored in the one or more databases;

obtaining, by the query engine and from the one or more databases, the plurality of testing examples;

obtaining, by the query engine and from the one or more databases, the parameter values of the machine learning model;

executing, by the query engine, the third user-defined function, comprising processing the plurality of testing examples using the machine learning model according to the obtained parameter values of the machine learning model to generate a measure of performance of the machine learning model; and

providing, to the user device and by the query engine, the generated measure of performance of the machine learning model.

Embodiment 7 is the method of any one of embodiments 1-6, further comprising refining the parameter values of the machine learning model, the refining comprising:

obtaining, from a fourth user device and by the query engine, a fourth command to execute a fourth user-defined function of the query engine, wherein:
the fourth command is written in the query language;
the fourth user-defined function has been written and launched onto the query engine by users of the query engine using one or more programming languages that are different from the query language in which the fourth command is written; and
fourth command comprises data identifying a plurality of second training examples stored in the one or more databases;

obtaining, by the query engine and from the one or more databases, the plurality of second training examples;

obtaining, by the query engine and from the one or more databases, the parameter values for the machine learning model;

executing, by the query engine, the fourth user-defined function, comprising processing the plurality of second training examples using the machine learning model according to the obtained parameter values of the machine learning model to generate refined parameter values of the machine learning model; and

storing, in the one or more databases, the refined parameter values of the machine learning model.

Embodiment 8 is the method of any one of embodiments 1-7, wherein the query language is a declarative query language and the one or more programming languages are imperative programming languages.

Embodiment 9 is a system comprising: one or more computers and one or more storage devices storing instructions that are operable, when executed by the one or more computers, to cause the one or more computers to perform the method of any one of embodiments 1 to 8.

Embodiment 10 is one or more non-transitory computer storage media encoded with a computer program, the program comprising instructions that are operable, when executed by data processing apparatus, to cause the data processing apparatus to perform the method of any one of embodiments 1 to 8.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method comprising:
obtaining, from a user device and by a query engine that is configured to access one or more databases, a command to execute a user-defined function of the query engine, wherein:
the command is written in a query language;
the user-defined function has been written and launched onto the query engine by users of the query engine using one or more programming languages that are different from the query language in which the command is written; and
the user-defined function includes an inference call to a trained machine learning model, wherein the command comprises one or more model inputs to the machine learning model;
obtaining, by the query engine and from the one or more databases, trained parameter values for the machine learning model;
executing, by the query engine, the user-defined function, comprising processing the one or more model inputs using the machine learning model according to the obtained parameter values of the machine learning model to generate respective model outputs; and
providing, to the user device and by the query engine, the generated model outputs.

2. The method of claim 1, wherein:
the command comprises a plurality of model inputs; and
executing the user-defined function further comprises executing the user-defined function on each of a plurality of nodes of the query engine, comprising processing each of the plurality of model inputs using the machine learning model on a respective node of the plurality of nodes.

3. The method of claim 1, further comprising training the machine learning model, the training comprising:
obtaining, from a second user device and by the query engine, a second command to execute a second user-defined function of the query engine, wherein:
the second command is written in the query language;
the second user-defined function has been written and launched onto the query engine by users of the query engine using one or more programming languages that are different from the query language in which the second command is written; and
the second command comprises data identifying a plurality of training examples stored in the one or more databases;
obtaining, by the query engine and from the one or more databases, the plurality of training examples;
executing, by the query engine, the second user-defined function, comprising processing the plurality of training examples using the machine learning model to generate trained parameter values for the machine learning model; and
storing, in the one or more databases, the trained parameter values.

4. The method of claim 3, wherein executing the second user-defined function further comprises executing the second user-defined function on each of a plurality of nodes of the query engine, comprising:
processing, by each of the plurality of nodes of the query engine, the plurality of training examples using the machine learning model according to a respective different set of hyperparameter values;
determining, for each of the plurality of different sets of hyperparameter values, a measure of performance of the set of hyperparameter values;
selecting a particular set of hyperparameter values from the plurality of different sets of hyperparameter values according to the determined measures of performance; and
generating the trained parameter values for the machine learning model according to the selected set of hyperparameter values.

5. The method of claim 3, wherein executing the second user-defined function further comprises pre-processing, by the query engine, the plurality of training examples before processing the training examples using the machine learning model.

6. The method of claim 1, further comprising evaluating the machine learning model, the evaluating comprising:
obtaining, from a third user device and by the query engine, a third command to execute a third user-defined function of the query engine, wherein:
the third command is written in the query language;
the third user-defined function has been written and launched onto the query engine by users of the query engine using one or more programming languages that are different from the query language in which the third command is written; and
the third command comprising data identifying a plurality of testing examples stored in the one or more databases;
obtaining, by the query engine and from the one or more databases, the plurality of testing examples;
obtaining, by the query engine and from the one or more databases, the parameter values of the machine learning model;
executing, by the query engine, the third user-defined function, comprising processing the plurality of testing examples using the machine learning model according to the obtained parameter values of the machine learning model to generate a measure of performance of the machine learning model; and
providing, to the user device and by the query engine, the generated measure of performance of the machine learning model.

7. The method of claim 1, further comprising refining the parameter values of the machine learning model, the refining comprising:
obtaining, from a fourth user device and by the query engine, a fourth command to execute a fourth user-defined function of the query engine, wherein:
the fourth command is written in the query language;
the fourth user-defined function has been written and launched onto the query engine by users of the query engine using one or more programming languages that are different from the query language in which the fourth command is written; and
fourth command comprises data identifying a plurality of second training examples stored in the one or more databases;
obtaining, by the query engine and from the one or more databases, the plurality of second training examples;
obtaining, by the query engine and from the one or more databases, the parameter values for the machine learning model;
executing, by the query engine, the fourth user-defined function, comprising processing the plurality of second training examples using the machine learning model according to the obtained parameter values of the machine learning model to generate refined parameter values of the machine learning model; and
storing, in the one or more databases, the refined parameter values of the machine learning model.

8. The method of claim 1, wherein the query language is a declarative query language and the one or more programming languages are imperative programming languages.

9. A system comprising one or more computers and one or more storage devices storing instructions that are operable, when executed by the one or more computers, to cause the one or more computers to perform operations comprising:
obtaining, from a user device and by a query engine that is configured to access one or more databases, a command to execute a user-defined function of the query engine, wherein:
the command is written in a query language;
the user-defined function has been written and launched onto the query engine by users of the query engine using one or more programming languages that are different from the query language in which the command is written; and
the user-defined function includes an inference call to a trained machine learning model, wherein the command comprises one or more model inputs to the machine learning model;
obtaining, by the query engine and from the one or more databases, trained parameter values for the machine learning model;
executing, by the query engine, the user-defined function, comprising processing the one or more model inputs using the machine learning model according to the obtained parameter values of the machine learning model to generate respective model outputs; and
providing, to the user device and by the query engine, the generated model outputs.

10. The system of claim 9, wherein:
the command comprises a plurality of model inputs; and
executing the user-defined function further comprises executing the user-defined function on each of a plurality of nodes of the query engine, comprising processing each of the plurality of model inputs using the machine learning model on a respective node of the plurality of nodes.

11. The system of claim 9, wherein the operations further comprise training the machine learning model, the training comprising:
obtaining, from a second user device and by the query engine, a second command to execute a second user-defined function of the query engine, wherein:
the second command is written in the query language;
the second user-defined function has been written and launched onto the query engine by users of the query engine using one or more programming languages that are different from the query language in which the second command is written; and
the second command comprises data identifying a plurality of training examples stored in the one or more databases;
obtaining, by the query engine and from the one or more databases, the plurality of training examples;
executing, by the query engine, the second user-defined function, comprising processing the plurality of training examples using the machine learning model to generate trained parameter values for the machine learning model; and
storing, in the one or more databases, the trained parameter values.

12. The system of claim 11, wherein executing the second user-defined function further comprises executing the second user-defined function on each of a plurality of nodes of the query engine, comprising:
processing, by each of the plurality of nodes of the query engine, the plurality of training examples using the machine learning model according to a respective different set of hyperparameter values;
determining, for each of the plurality of different sets of hyperparameter values, a measure of performance of the set of hyperparameter values;
selecting a particular set of hyperparameter values from the plurality of different sets of hyperparameter values according to the determined measures of performance; and
generating the trained parameter values for the machine learning model according to the selected set of hyperparameter values.

13. The system of claim 11, wherein executing the second user-defined function further comprises pre-processing, by the query engine, the plurality of training examples before processing the training examples using the machine learning model.

14. The system of claim 9, wherein the operations further comprise evaluating the machine learning model, the evaluating comprising:
obtaining, from a third user device and by the query engine, a third command to execute a third user-defined function of the query engine, wherein:
the third command is written in the query language;
the third user-defined function has been written and launched onto the query engine by users of the query engine using one or more programming languages that are different from the query language in which the third command is written; and
the third command comprising data identifying a plurality of testing examples stored in the one or more databases;
obtaining, by the query engine and from the one or more databases, the plurality of testing examples;
obtaining, by the query engine and from the one or more databases, the parameter values of the machine learning model;
executing, by the query engine, the third user-defined function, comprising processing the plurality of testing examples using the machine learning model according to the obtained parameter values of the machine learning model to generate a measure of performance of the machine learning model; and
providing, to the user device and by the query engine, the generated measure of performance of the machine learning model.

15. The system of claim 9, wherein the operations further comprise refining the parameter values of the machine learning model, the refining comprising:
obtaining, from a fourth user device and by the query engine, a fourth command to execute a fourth user-defined function of the query engine, wherein:
the fourth command is written in the query language;
the fourth user-defined function has been written and launched onto the query engine by users of the query engine using one or more programming languages that are different from the query language in which the fourth command is written; and
fourth command comprises data identifying a plurality of second training examples stored in the one or more databases;
obtaining, by the query engine and from the one or more databases, the plurality of second training examples;
obtaining, by the query engine and from the one or more databases, the parameter values for the machine learning model;
executing, by the query engine, the fourth user-defined function, comprising processing the plurality of second training examples using the machine learning model according to the obtained parameter values of the machine learning model to generate refined parameter values of the machine learning model; and
storing, in the one or more databases, the refined parameter values of the machine learning model.

16. The system of claim 9, wherein the query language is a declarative query language and the one or more programming languages are imperative programming languages.

17. One or more non-transitory computer storage media encoded with computer program instructions that when executed by a plurality of computers cause the plurality of computers to perform operations comprising:
obtaining, from a user device and by a query engine that is configured to access one or more databases, a command to execute a user-defined function of the query engine, wherein:
the command is written in a query language;
the user-defined function has been written and launched onto the query engine by users of the query engine using one or more programming languages that are different from the query language in which the command is written; and
the user-defined function includes an inference call to a trained machine learning model, wherein the command comprises one or more model inputs to the machine learning model;
obtaining, by the query engine and from the one or more databases, trained parameter values for the machine learning model;
executing, by the query engine, the user-defined function, comprising processing the one or more model inputs using the machine learning model according to the obtained parameter values of the machine learning model to generate respective model outputs; and
providing, to the user device and by the query engine, the generated model outputs.

18. The non-transitory computer storage media of claim 17, wherein:
the command comprises a plurality of model inputs; and
executing the user-defined function further comprises executing the user-defined function on each of a plurality of nodes of the query engine, comprising processing each of the plurality of model inputs using the machine learning model on a respective node of the plurality of nodes.

19. The non-transitory computer storage media of claim 17, wherein the operations further comprise training the machine learning model, the training comprising:
obtaining, from a second user device and by the query engine, a second command to execute a second user-defined function of the query engine, wherein:
the second command is written in the query language;
the second user-defined function has been written and launched onto the query engine by users of the query engine using one or more programming languages that are different from the query language in which the second command is written; and
the second command comprises data identifying a plurality of training examples stored in the one or more databases;
obtaining, by the query engine and from the one or more databases, the plurality of training examples;
executing, by the query engine, the second user-defined function, comprising processing the plurality of training examples using the machine learning model to generate trained parameter values for the machine learning model; and
storing, in the one or more databases, the trained parameter values.

20. The non-transitory computer storage media of claim 19, wherein executing the second user-defined function further comprises executing the second user-defined function on each of a plurality of nodes of the query engine, comprising:
processing, by each of the plurality of nodes of the query engine, the plurality of training examples using the machine learning model according to a respective different set of hyperparameter values;
determining, for each of the plurality of different sets of hyperparameter values, a measure of performance of the set of hyperparameter values;
selecting a particular set of hyperparameter values from the plurality of different sets of hyperparameter values according to the determined measures of performance; and
generating the trained parameter values for the machine learning model according to the selected set of hyperparameter values.

21. The non-transitory computer storage media of claim 19, wherein executing the second user-defined function further comprises pre-processing, by the query engine, the plurality of training examples before processing the training examples using the machine learning model.

22. The non-transitory computer storage media of claim 17, wherein the operations further comprise evaluating the machine learning model, the evaluating comprising:
obtaining, from a third user device and by the query engine, a third command to execute a third user-defined function of the query engine, wherein:
the third command is written in the query language;
the third user-defined function has been written and launched onto the query engine by users of the query engine using one or more programming languages that are different from the query language in which the third command is written; and
the third command comprising data identifying a plurality of testing examples stored in the one or more databases;
obtaining, by the query engine and from the one or more databases, the plurality of testing examples;
obtaining, by the query engine and from the one or more databases, the parameter values of the machine learning model;
executing, by the query engine, the third user-defined function, comprising processing the plurality of testing examples using the machine learning model according to the obtained parameter values of the machine learning model to generate a measure of performance of the machine learning model; and
providing, to the user device and by the query engine, the generated measure of performance of the machine learning model.

23. The non-transitory computer storage media of claim 17, wherein the operations further comprise refining the parameter values of the machine learning model, the refining comprising:
obtaining, from a fourth user device and by the query engine, a fourth command to execute a fourth user-defined function of the query engine, wherein:
the fourth command is written in the query language;
the fourth user-defined function has been written and launched onto the query engine by users of the query engine using one or more programming languages that are different from the query language in which the fourth command is written; and
fourth command comprises data identifying a plurality of second training examples stored in the one or more databases;
obtaining, by the query engine and from the one or more databases, the plurality of second training examples;
obtaining, by the query engine and from the one or more databases, the parameter values for the machine learning model;
executing, by the query engine, the fourth user-defined function, comprising processing the plurality of second training examples using the machine learning model according to the obtained parameter values of the machine learning model to generate refined parameter values of the machine learning model; and
storing, in the one or more databases, the refined parameter values of the machine learning model.

24. The non-transitory computer storage media of claim 17, wherein the query language is a declarative query language and the one or more programming languages are imperative programming languages.
